(19) United States
(12) Patent Application Publication
(10) Pub. No.: US 2015/0053272 A1
(43) Pub. Date: Feb. 26, 2015

(54) PRESSURE STABILIZATION METHOD

(71) Applicant: SEIMENS AKTIENGESELLSCHAFT, München (DE)

(72) Inventor: Klaus Weinzierl, Nuremberg (DE)

(73) Assignee: SIEMENS AKTIENGESELLSCHAFT, München (DE)

(21) Appl. No.: 14/388,690

(22) PCT Filed: Mar. 18, 2013
(86) PCT No.: PCT/EP2013/055547

§ 371 Date: Sep. 26, 2014

(30) Foreign Application Priority Data
Mar. 27, 2012 (EP) 12161385.5

(51) Int. Cl. G05D 16/18; F17D 1/12; B21B 45/02; G05D 16/20

(52) U.S. Cl. CPC G05D 16/18; G05D 16/2093; F17D 1/12; B21B 45/0218
USPC 137/14; 137/156

(57) ABSTRACT

The pressure of a water supply of a cooling section of a metal processing line is stabilized by supplying the cooling section with water from a water reservoir by a pipeline which is filled with water and providing a pressure container partly filled with air and partly with water. A direct connection is provided for a direct exchange of water between the pressure container and the pipeline. Water is pressed out of the pressure container directly into the pipeline through the provided connection in the event that the water pressure in the pipeline drops.

### CROSS REFERENCE TO RELATED APPLICATIONS

This application is the U.S. national stage of International Application No. PCT/EP2013/055547, filed Mar. 18, 2013 and claims the benefit thereof. The International Application claims the benefit of European Application No. 12161385 filed on Mar. 27, 2012, both applications are incorporated by reference herein in their entirety.

### BACKGROUND

Described below is a method for stabilizing the pressure of the water supply of a cooling section and a corresponding water supply system.

To cool metal strip, e.g. steel strip, it is a known technique to apply water as a coolant to this strip in a cooling section. A relatively large flow of water is needed for the cooling section of a hot strip line. To achieve a high level of accuracy of the temperature management in the cooling section, it is important in this respect that during the activation of valves in the cooling section, the water pressure remains constant irrespective of the flow of water drawn off or at least can be described in stable terms as a function of the connected water flow. In the latter case, the water pressure can then be recorded and taken into account in a cooling model, e.g. with modeling or measurement of the water pressure, so as to achieve accurate temperature management.

The water supply of a cooling section is typically decoupled from the public water supply with the aid of a high-level tank so as to exclude unpredictable fluctuations of the water pressure. DE 198 50 253 A1 describes the regulation of a cooling section supplied with water from a high-level water container.

It is not always possible, however, particularly in the case of modernizations, to install a high-level tank in the immediate vicinity of the cooling section. The water often has to be brought to the cooling section first via a relatively long pipeline. Typical pipeline lengths lie in the range 100 to 300 m, i.e. when the cooling section is switched on, a relatively large volume of water, typically several hundred tons of water, has to be brought up to speed. As a result, switching on the cooling section does not bring about the desired rise in water flow right away, but instead a fall in pressure at first, and the desired rise in water flow to the required pressure level only after a lengthy period, once the water column situated in the pipeline has been brought up to speed. A similar pressure fluctuation occurs in the case of opening additional valves of a cooling section in operation, i.e. in the case of a distribution of the previously available water flow to a larger quantity of valves.

Although regulating the water flow with the aid of a bypass valve obviates the short-term acceleration of large volumes of water, this results in high water and energy consumption.

### SUMMARY

The method described below provides an improved water supply for a cooling section.

Described below is a method for stabilizing the pressure of the water supply of a cooling section for a metal processing line, wherein the cooling section is supplied with water from a water reservoir through a pipeline filled with water, wherein the method includes: provision of a pressure container partly filled with air and partly with water; and provision of a direct connection for a direct exchange of water between the pressure container and the pipeline such that in the event that the water pressure in the pipeline drops, water is pressed directly into the pipeline out of the pressure container through the connection provided. Also described below is a water supply system for a cooling section of a metal processing line, including a pipeline filled with water through which the cooling section can be supplied with water from a water reservoir, a pressure container partly filled with air and partly with water, and a direct connection for a direct exchange of water between the pressure container and the pipeline such that in the event that the water pressure in the pipeline drops, water is pressed directly into the pipeline out of the pressure container through the connection provided.

The water in the pressure container is connected to the water column in the pipeline between the cooling section and the water reservoir via a direct connection in the form of a water-filled feed pipe. Any change in pressure in the pipeline therefore has a direct effect on the pressure container, i.e. without the intermediate connection of further water volumes subject to mass inertia—apart from the relatively small and faster-accelerating water volume, as compared to the water volume in the pipeline leading from the water reservoir to the cooling section, in the water-filled connection between the pressure container and the pipeline; the pressure response of the pressure container to a fall in pressure in the pipeline can take place correspondingly rapidly.

In this respect, the water reservoir exposed to pressure fluctuations can be a public water supply network, a water cistern or some other water source, i.e. a waterway. The transportation of the water from the water reservoir to the cooling section can be effected with the aid of a pump or by released kinetic energy of the water if the water is brought from a water reservoir in an elevated location with respect to the cooling section.

The method is based on the finding that maintenance of constant pressure in the water supply of a cooling section can be implemented not only, as in a known manner, with a water reservoir, such as a high-level water container, but also with a pressure container used as a pressure equalization vessel which is connected to the pipeline used for the water supply for the cooling section. The terms “pressure container” and “pressure equalization vessel” are used with the same meaning below.

The water reservoir and the pressure container do not have the same function in this respect; they are different devices acting independently of each another. Simply on the basis of its capacity, which is typically relatively small, the pressure container would not be suitable for making a substantial contribution to the water supply of a cooling section over an extended period. The pressure container is used merely temporarily as a pressure equalization vessel and is installed additionally to and independently of the water reservoir. The method does not require any modification of an existing water reservoir; this can remain imperfect, i.e. generating constant pressure fluctuations. The pressure container provides an opportunity to implement pressure stabilization solely by its means.

The pressure equalization vessel allows a fall in pressure in the pipeline to be considerably reduced if an increased water flow is required in the cooling section, e.g. when the cooling section is switched on or when additional valves are opened during the operation of the cooling section. In the time until the water column in the pipeline used as a feed pipe to the cooling section is accelerated to an adequate speed, the water required is supplied from the pressure container. This supplying of the cooling section with water from the pressure container is possible because the air in the pressure container expands in the case of a fall in pressure in the pipeline and presses water out of the pressure container. This temporary feeding of water from the pressure container counteracts the fall in pressure in the pipeline.

Accordingly, therefore, a decoupling of the cooling section from fluctuations in the water pressure of the water supply system is achieved with the aid of the pressure container, which is used as a pressure equalization vessel for the pipeline. The pressure container is partly filled with water, with a cushion of compressed air being situated above the water. For example, the pressure container is half filled with water and half with air. The pressure container may be connected at the cooling section end of a potentially relatively long pipeline that interconnects the water reservoir and the cooling section. A relatively long pipeline is considered to be one with a length in the range 100 to 300 m.

The method offers a range of advantages:
The method results, with a small storage volume of the pressure equalization vessel compared to a known high-level water tank, in a minimization of pressure fluctuations. The necessary volume of the pressure container is substantially smaller than in the case of a high-level tank. Typical volumes of the pressure container include 10 to 20 cubic meters whereas a high-level tank typically contains at least 100 cubic meters of water.
The method results in a significant damping down of pressure fluctuations in the water resources. The damping down is so marked that during the activation of valves in the cooling section, the water pressure can be described in stable terms as a function of the connected water flow. This allows a cooling model to be designed such that the predictable or measured water pressure fluctuations can be evened out. In the case of water supply systems without a pressure equalization vessel, there is always a risk of the water resources being destabilized: the cooling model would take water away, e.g. in the case of a rise in pressure, and thus further reinforce the rise in pressure. The water supply would subsequently become unstable.
A higher water pressure at the cooling section can be implemented easily, specifically by increasing the internal pressure in the pressure equalization vessel. A high-level tank, on the other hand, requires a construction height of 10 m per bar of water pressure.
The method does not result in higher energy and water consumption compared to a bypass valve.
The method permits a prompt response with no further delay, in contrast to a solution with a bypass valve.
Due to its relatively small volume and the resulting relatively small dimensions, the pressure container can be easily integrated into an existing water supply system. In particular, the pressure container can be arranged relative to the pipeline such that no air escapes from the pressure container into the pipeline if the pipeline becomes depressurized, e.g. if there is a failure of water pumps. This advantage is particularly valuable in practice since air situated in a water supply system for cooling a cooling section can result in enormous damage during operation of the water cooling and must always be avoided.

The direct connection between the pressure container and the pipeline may open into the pipeline as close as possible to cooling line valves that regulate the water flow through the pipeline and therefore the water feed to the cooling section. When the cooling line valves are opened, the short-term fall in pressure in the pipeline is created at the point where the water column no longer experiences any limitation, i.e. at the cooling line valves. This fall in pressure can be equalized all the faster, the closer to the valves the water being fed from the pressure container meets the water column in the pipeline. The fall in pressure is combated, as it were, as close as possible to the place where it is created.

If typical pipeline lengths between the water reservoir and the cooling line valves in the range 100 to 300 m are assumed, then it is advantageous if the water feed pipe from the pressure container opening into the pipeline opens into the pipeline in the latter half, and preferably in the latter third, and more preferably in the latter quarter, and more preferably in the latter fifth of the pipeline length before the cooling line valves.

According to an embodiment of the invention, the method additionally includes adjustment of the volume of air in the pressure container. The adjustment of the air volume can take place or become necessary for various reasons, e.g.
If the air volume in the pressure container has become too small. This can be the case if part of the air has gone into solution in the water;
If the air volume in the pressure container has become too large. This can be the case if the air dissolved in the water escapes as air bubbles and/or if air bubbles contained in the water rise to the water surface and release air there so that the air volume in the container gradually rises;
As an additional control measure: if the pressure in the pressure container falls, air can be topped up as an additional measure to slow down the fall in pressure. For example, a situation can arise where the air volume increases, where p V=const., because water has been pressed into the pipeline. In this case, the container increasingly loses the capability to press further water into the pipeline. Simultaneous topping up of air during the fall in pressure allows the fall in pressure to be slowed down;
As an additional safety measure: if the fill level of the water in the pressure container becomes too low, a backflow of water into the container can be triggered by a discharge of air. As a result, the fill level of the water in the pressure container rises again;
To ensure that in the event of the water pressure in the pipeline dropping, water is pressed out of the pressure container through the connection provided and into the pipeline.

For this purpose, the water supply system adjusts the volume of air in the pressure container.

According to an embodiment of the invention, the connection between the pressure container and the pipeline is restricted or shut off. To this end, the water supply system can have a restrictor facility that is realized in the form of a valve, in particular a shut-off valve, or a blocking flap valve. The term “restrictor facility” is understood to mean any device for limiting the throughput, i.e. any means for restricting or shutting off. The restrictor facility acts as a resistance to the flow. If the restrictor facility is movable, the damping down of the pipeline is therefore also adjustable. It must be borne in mind in this respect that the compressed air in the pressure container acts like a spring and the mass of the water column in the pipeline like a pendulum; taken as a whole, therefore, it is a system capable of oscillation. This oscillatory system can be damped down by a flow resistance in the outflow of the pressure container that damps down the tendency of the system to oscillate. Although the flow resistance can result in larger pressure fluctuations at the cooling section again, these can be easily calculated or recorded and taken into account in the cooling model for the cooling section if the system as a whole responds with good damping and does not induce oscillations in the case of changes in the volume of water.

If a restrictor facility is arranged in the outlet of the pressure container, valves can be operated as rapidly as desired in the cooling section without having to worry about pressure surges, or without large oscillations destabilizing, via the water resources, a cooling section control mechanism that records the water pressure and evens out pressure fluctuations. This restrictor facility, which may be realized in the form of a valve, can be implemented so as to be adjustable. The damping can then be adapted. If the restrictor facility can be moved by electrically, the damping can even be adapted dynamically and the restrictor facility integrated into a pressure control loop as a dynamic actuator. Furthermore, a restrictor facility of this type in the outlet of the pressure container can also carry out a safety function. If the fill level in the pressure container becomes too low because of a fault occurring, the pressure container is shut off by the restrictor facility in the outlet and thus safely isolated from the water supply.

According to an embodiment of the invention, the connection between the pressure container and the pipeline is shut off if the fill level of the water in the pressure container drops below a predefined threshold value. Indeed, a situation where the air in the pressure container presses the water situated in the pressure container completely out of the pressure container and as a result compressed air is possibly also blown into the pipeline, i.e. the water resources, must always be avoided. Water in the water supply pipes for the cooling section can in fact result in considerable problems, and also damage to equipment assemblies of the water supply for the cooling section.

In a development of the invention, the fill level of the water in the pressure container is measured. The water level may be measured in the pressure equalization vessel. It is possible in this respect for the water supply system to include a sensor for measuring the fill level of the water in the pressure container. It is advantageous for the volume of air in the pressure container to be recalibrated occasionally since otherwise the air volume in the pressure container can change over time. Measurement of the water level allows an excessively low water fill level to be identified at an early stage and water to be topped up, into the pressure container. Topping up water into the pressure container can be effected as a result of the air volume in the pressure container being reduced: the resulting fall in pressure in the pressure container then results in a backflow of water from the pipeline into the pressure container.

By using level measurement of this type in the pressure container, i.e. measurement of the fill level of the water in the pressure container, it is even possible for active regulation of the air supply to the pressure container to take place. But it is also possible for the air volume in the pressure container to be recalibrated only occasionally, e.g. during idle phases.

It is advantageous to measure the pressure in the interior of the pressure container. To this end, the water supply system can have a sensor for measuring the pressure in the pressure container. It is possible for the water pressure in the pipeline to be measured. To this end, the water supply system can have a sensor for measuring the water pressure in the pipeline. A pressure sensor for measuring the water pressure in the pipeline can be advantageously attached at the outlet of the pressure container, such as downstream of the restrictor facility, i.e. on the side of the restrictor facility facing the pipeline. The pressure in the interior of the pressure container is then known at all times and also the pressure with which the cooling section is supplied with water. Pressure measurement in the interior of the pressure container improves control of the compressed air in the pressure container; the pressure measurement downstream of the restrictor facility is fed to the cooling model for the cooling section and thus improves control of the cooling section.

It is possible for a feed to be situated in the upper part of the pressure container, with which compressed air can be fed to the pressure container. Air can also be removed from the pressure container via a further opening. But a common feed and removal of air to and from the pressure container is also possible if the air supply is operated with a variable air pressure. Air is then removed from the pressure container if the air pressure of the air supply is lower than the air pressure in the pressure container, and air is fed to the pressure container if the air pressure of the air supply is higher than the air pressure in the pressure container.

According to an development of the invention, the pressure container has a volume in the range 10 to 20 m³. In the case of the water flows needed for cooling a cooling section of typical size, a volume of less than 10 m³ can result in inadequate pressure stabilization. On the other hand, the dimensions of a pressure container with a volume of more than 20 m³ can result in limitations with regard to simple integration in an existing cooling section. Moreover, the costs of a pressure container rise with its volume. A pressure container with a volume in the range 10 to 20 m³ therefore represents a good compromise.

The water reservoir and the pressure container do not have a direct fluid connection but are instead connected via a segment of the pipeline that feeds water from the water reservoir to the cooling section. The water reservoir and the pressure container may be mutually independent containers arranged in different positions.

### BRIEF DESCRIPTION OF THE DRAWINGS

The properties, features, and advantages described above and also the manner of obtaining them will become more clearly and unambiguously comprehensible in conjunction with the following description of exemplary embodiments, which are explained in more detail in conjunction with the drawings which are schematic and not-to-scale, where

FIG. 1 is a block diagram of a first exemplary embodiment of a water supply system for a cooling section;

FIG. 2 is a block diagram of a further exemplary embodiment of a water supply system for a cooling section;

FIG. 3 is a block diagram of a pressure container while a cooling section is being switched on;

FIG. 4 is a block diagram of a pressure container while a cooling section is being switched off;

FIG. 5 is a block diagram of an exemplary embodiment of a pressure container;

FIG. 6 is a block diagram of a further exemplary embodiment of a pressure container; and

FIG. 7 is a block diagram of a pipeline with a connected pressure equalization vessel for estimating oscillation damping.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

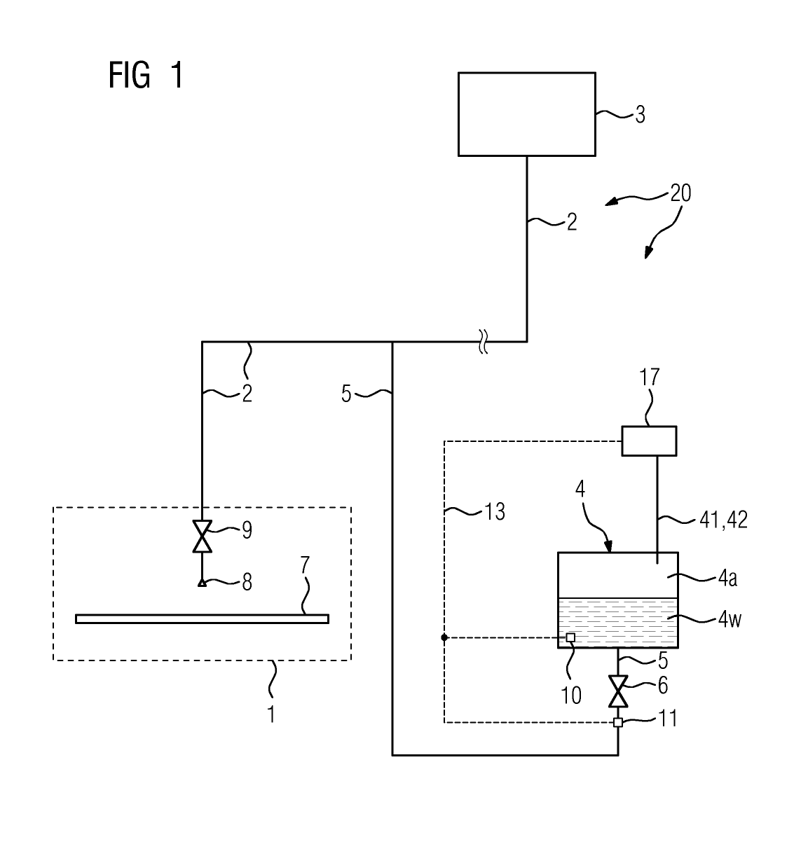

FIG. 1 shows a cooling section 1 and a water supply system 20 assigned to same. The cooling section 1 includes cooling nozzles 8, via which cooling water flows on to a metal strip 7 to be cooled. The water feed to the cooling nozzles is controlled by one or more cooling line valves 9.

The water supply system 20 includes a pipeline 2 filled with water, through which the cooling section 1 can be supplied with water from a water reservoir 3, a pressure container 4 partly filled with air 4a and partly with water 4w, a connecting pipe 5 for exchanging water between the pressure container 4 and the pipeline 2, and a compressed air system 17 for adjusting the pressure in the pressure container 4.

The water reservoir 3 can be a public water supply network, a water cistern, in particular a high-level water container, e.g. installed on a water tower, or some other water source, e.g. a waterway. In the exemplary embodiment shown, transportation of the water from the water reservoir to the cooling section is effected by released kinetic energy of the water since the water is brought from a water reservoir 3 in an elevated location with respect to the cooling section 1.

The pressure container 4 can be formed of any material which is resistant to both pressure and coolant, e.g. steel or aluminum. The shape of the pressure container 4 is selected such that the pressure container 4 can withstand the internal pressures arising; for example, the pressure container 4 has a cylindrical part which is closed off by two outward bulging or flat bases. One or more holes are realized in the outer wall of the pressure container 4 through which coolant 4w and air 4a can be fed and removed, and also one or more sensors are introduced into the interior of the pressure container 4. These holes are sealed so as to be pressure-tight.

The compressed air system 17 conveys compressed air, via the combined air inlet and outlet 41, 42, into the pressure container 4 if the air volume in same is to be increased. Conversely, the compressed air system 17 removes air, via the combined air inlet and outlet 41, 42, from the pressure container 4 if the air volume in same is to be reduced.

The water supply system 20 additionally includes a pressure sensor 10 for measuring the pressure in the pressure container 4 and a pressure sensor 11 for measuring the pressure in the pipeline 2. The measured pressure values of the two sensors 10, 11 are transmitted in the form of measurement signals via signal lines 13 to a control unit of the compressed air system 17 not shown separately in FIG. 1. On the basis of the signals received, the compressed air system 17 determines whether air has to be conveyed into or out of the pressure container 4 to adjust the pressure conditions such that in the event that the water pressure in the pipeline 2 drops, water is pressed into the pipeline 2 out of the pressure container 4 through the connection 5 provided.

For example, the compressed air system 17 holds the internal pressure of the pressure container 4 at a pressure that prevailed in the pipeline 2, e.g., as an average value of a preceding period, e.g. the last five seconds. As a result, pressure fluctuations in the pipeline 2 are damped down even more strongly.

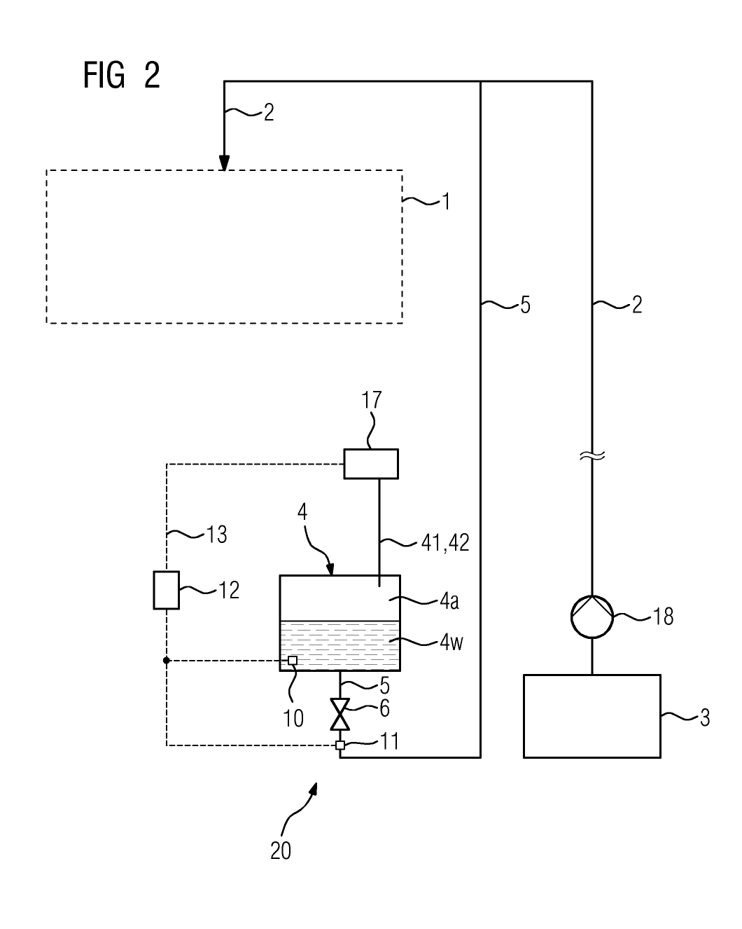

FIG. 2 shows a cooling section 1 and a water supply system 20 assigned to same according to a further exemplary embodiment. With regard to a possible embodiment of the cooling section 1, reference is made to the corresponding description relating to FIG. 1.

The water supply system 20 also corresponds substantially to that shown in FIG. 1, apart from the difference that the pressure measurement signals of the two pressure sensors 10, 11 are collected and processed in a separate pressure measurement unit 12. On the basis of these pressure measurement signals, the pressure measurement unit 12 generates control signals that are sent to the compressed air system 17 and used for control of the compressed air system 17.

A further difference between the water supply systems 20 shown in FIG. 1 and FIG. 2 is that in the case of the water supply system 20 shown in FIG. 2, transportation of the water from the water reservoir 3 to the cooling section is effected with the aid of a pump 18. Due to the damping and equalizing effect of the pressure container 4 on the pressure conditions in the pipeline 2, pressure fluctuations caused by the switching on and off of the pump 18 can be damped down to the extent that they do not impair the operation of the cooling section 1, in particular the cooling of metal strip.

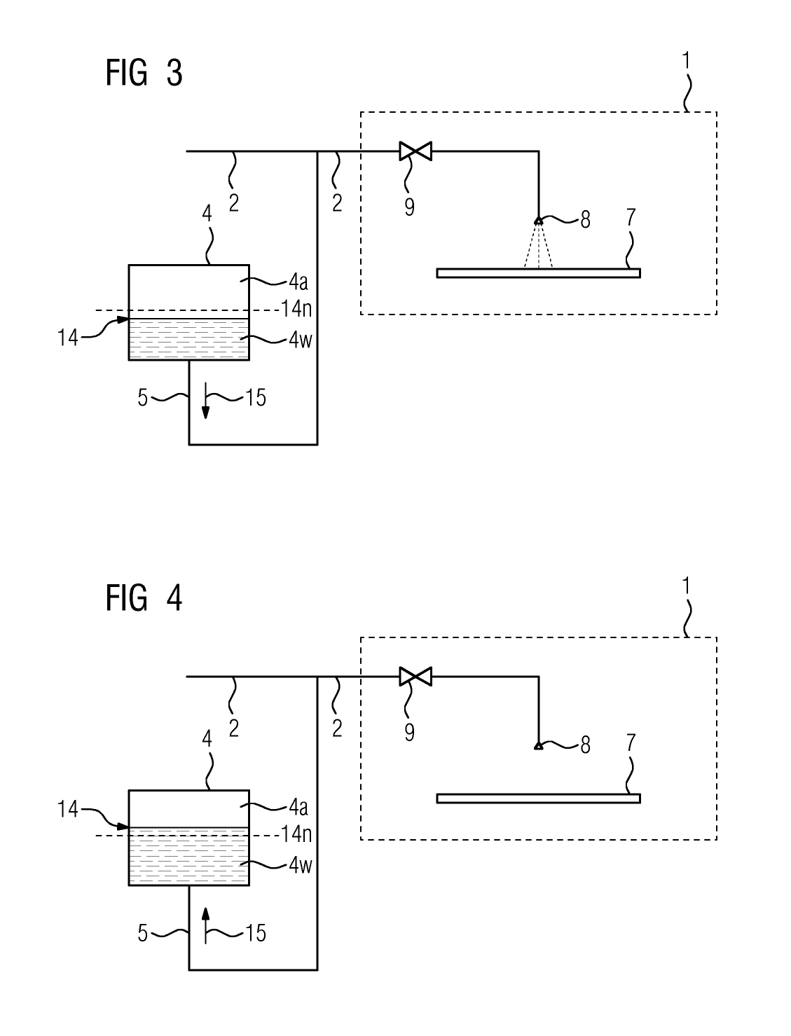

FIG. 3 shows a pressure container 4 immediately after a cooling section 1 is switched on. At the moment when the cooling line valve 9 is opened, a certain volume of water per unit of time, i.e. a flow of water, is suddenly removed from the pipeline 2. Since the water column situated in the pipeline 2 cannot flow after same instantaneously due to inertia and friction, there is initially a fall in pressure in the pipeline 2. This fall in pressure in the pipeline 2 is largely equalized, however, as a result of water being pressed out of the pressurized pressure container 4 through the connecting pipe 5 into the pipeline 2. The arrow 15 indicates the direction of flow of the water out of the pressure container 4.

In the pressure container 4, which is partly filed with water 4w and partly with air 4a, the outflow of water is evidenced by a dropping of the water level 14 below a normal level 14n. The normal level 14n establishes itself after lengthy stoppage or operation of the cooling section 1, i.e. under constant pressure conditions.

FIG. 4 shows the pressure container 4 already known from FIG. 3 but, in contrast to FIG. 3, immediately after the cooling section 1 is switched off. At the moment when the cooling line valve 9 is closed, the flow of water previously moving through the pipeline 2 is suddenly interrupted. Since the water column flowing through the pipeline 2 cannot stop instantaneously due to inertia and friction, there is initially a rise in pressure in the pipeline 2. This rise in pressure in the pipeline 2 is largely equalized, however, as a result of water being pressed out of the pipeline 2 through the connecting pipe 5 into the pressurized pressure container 4. The arrow 15 indicates the direction of flow of the water into the pressure container 4.

In the pressure container 4, which is partly filed with water 4w and partly with air 4a, the inflow of water is evidenced by a rising of the water level 14 above the normal level 14n.

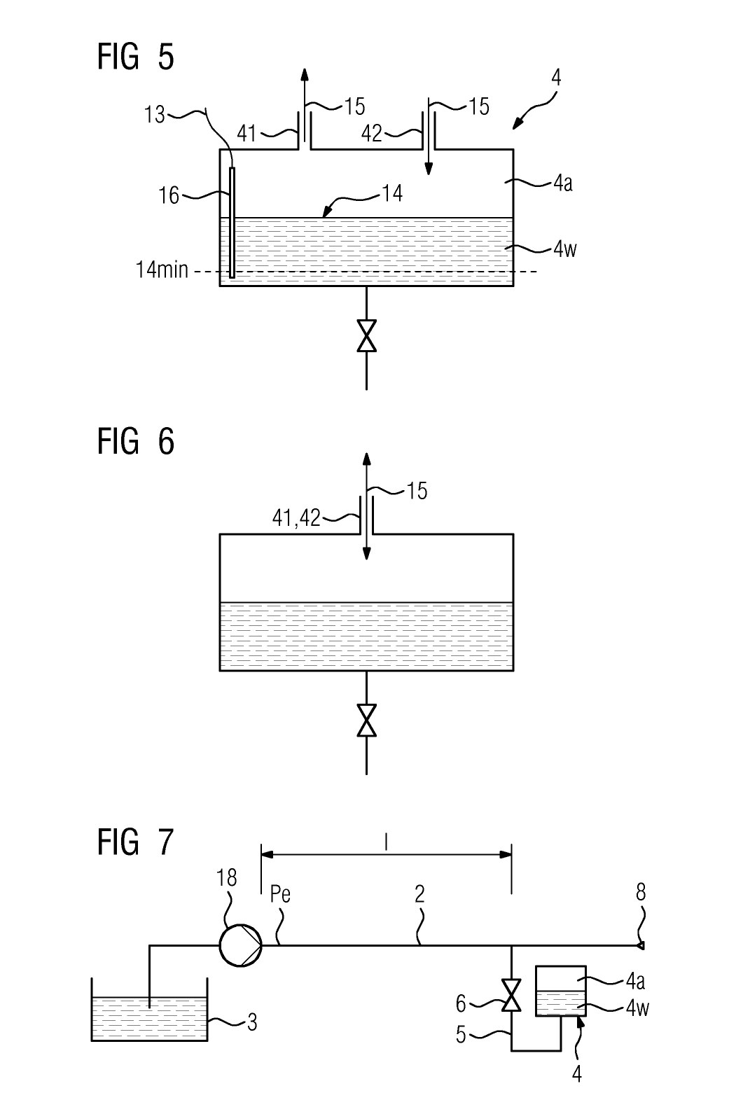

FIG. 5 shows a pressure container 4 in the interior of which, e.g. on a side wall, a fill level sensor 16 is arranged. The fill level sensor 16 measures the water level 14 of the water 4w in the pressure container 4 and delivers the corresponding measured value via a signal line to a control instrument. The measurement and likewise the signal generation can be effected respectively after a predefined time interval. If the level 14 falls below a threshold level 14 min, the control instrument can cause water to be conveyed into pressure container 4. This effected by activating a pump, which pumps water into the pressure container 4 via a separate feed pipe. Alternatively, the water for topping up the pressure container 4 originates from the pipeline 2, with this water being pressed through the connecting pipe 5 into the pressure container 4.

The pressure container 4 shown in FIG. 5 further includes an air outlet 41 and an air inlet 42. As a result, the pressure in the pressure container 4 can be controlled by feeding or discharging air. The direction of flow of the air in the air pipes 41, 42 is indicated by the arrows 15. It is therefore possible, by way of the discharging of air from the pressure container 4 through the air outlet 41, for the pressure in the pressure container 4 to be lowered to the extent that water is pressed out of the pipeline 2 into the pressure container 4.

FIG. 6 shows a pressure container 4 that has a combined air inlet and outlet 41, 42. The two possible directions of flow of the air in the combined air inlet and outlet 41, 42 are indicated by the arrow 15.

FIG. 7 shows an outline of a pipeline 2 with a pump 18 at the input and a pressure equalization vessel 4 at the output. With the aid of the water pump 18, water is pumped from a water reservoir 3 through the pipeline 2 with a pipe cross-section AR to a cooling nozzle 8. There is a pressure pₑ in the pipeline 2 at the output side of the pump 18. For the purpose of equalizing pressure in the pipeline 2, the pressure container 4 is connected to the pipeline 2 by a connecting pipe 5 at a distance 1 from the pump 18. In this respect, a shut-off valve 6 acting as a damping element, with a flow resistance R, is situated in the connecting pipe 5. The air 4a in the pressure container 4 has a volume v. There is an instantaneous pressure pₐ. in the pressure container 4. A damping D of the restrictor facility 6 is estimated for this situation below.

In the pressure container 4, the balance of the pressures is:

$${V}_{0} {p}_{0} = {vp}_{a} or {p}_{a} = \frac{{V}_{0} {p}_{0}}{v} \qquad I )$$

where the initial volume is V0, the initial pressure is p0, and the instantaneous volume is v.

Furthermore:

$${p}_{e} + \frac{ρ l}{{A}_{R}} \ddot{v} + R \dot{v} = {p}_{a} \qquad II )$$

where the density of water is ρ=1000 kg/m³. For the derivation, see e.g. Heinemann, Ekkehard; Feldhaus, Rainer: Hydraulik für Bauingenieure, 2nd edition, Stuttgart; Leipzig; Wiesbaden; B. G. Teubner, 2003, ISBN 3-519-15082-4. Inserting I) into II), and using the abbreviation v=V0x, produces:

$${p}_{e} + \frac{ρ l}{{A}_{R}} {V}_{0} \ddot{x} + {RV}_{0} \dot{x} - \frac{{p}_{0}}{x} = 0$$

Using the linearization x=x0+dx provides:

$${dp}_{e} + \frac{ρ {lV}_{0}}{{A}_{R}} d \ddot{x} + RVd \dot{x} + \frac{{p}_{0}}{{x}_{0}^{2}} dx = 0$$

Multiplying by

$$\frac{{x}_{0}^{2}}{{p}_{0}} ,$$

this provides:

$$\frac{{x}_{0}^{2}}{{p}_{0}} {dp}_{e} + {T}^{2} d \ddot{x} + TDd \dot{x} + dx = 0$$

$$where$$

$$T = \sqrt{\frac{{x}_{0}^{2} ρ {lV}_{0}}{{A}_{R} {p}_{0}}}$$

$$and$$

$$D = \frac{{RV}_{0}}{T}$$

If D=1 is assumed for good damping, then the flow resistance R must be selected in a suitable manner.

Although the invention has been specifically illustrated and described in detail by the exemplary embodiments, it is not limited by the disclosed examples. A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-15. (canceled)

16. A method for stabilizing water pressure of a water supply of a cooling section for a metal processing line, where the cooling section is supplied with water from a water reservoir through a pipeline filled with water, said method comprising:
providing a pressure container partly filled with air and partly filled with water; and
directly connecting the pressure container and the pipeline, thereby providing a direct exchange of water between the pressure container and the pipeline, whereby when water pressure in the pipeline drops, water is pressed directly into the pipeline out of the pressure container.

17. The method as claimed in claim 16, further comprising adjusting a volume of air in the pressure container.

18. The method as claimed in claim 17, further comprising at least one of restricting and shutting off the direct exchange of water between the pressure container and the pipeline.

19. The method as claimed in claim 18, wherein said restricting the direct exchange of water between the pressure container and the pipeline shuts off the direct exchange of water if a fill level of the water in the pressure container drops below a predefined threshold value.

20. The method as claimed in claim 16, further comprising measuring a fill level of the water in the pressure container.

21. The method as claimed in claim 16, further comprising measuring air pressure in the pressure container.

22. The method as claimed in claim 16, further comprising measuring the water pressure in the pipeline.

23. A water supply system for supplying water from a water reservoir to a cooling section of a metal processing line, comprising
a pipeline filled with water through which the cooling section is supplied with water from the water reservoir;
a pressure container partly filled with air and partly with water; and
a direct connection providing a direct exchange of water between the pressure container and the pipeline, whereby when water pressure in the pipeline drops, water is pressed directly into the pipeline out of the pressure container through the direct connection.

24. The water supply system as claimed in claim 23, further comprising means for adjusting a volume of air in the pressure container.

25. The water supply system as claimed in claim 23, further comprising a restrictor facility restricting the direct connection between the pressure container and the pipeline.

26. The water supply system as claimed in claim 25, wherein the restrictor facility includes a valve.

27. The water supply system as claimed in claim 25, wherein the restricting by the restrictor facility includes shutting off the direct connection.

28. The water supply system as claimed in claim 23, further comprising a sensor measuring a fill level of the water in the pressure container.

29. The water supply system as claimed in claim 23, further comprising a sensor measuring air pressure in the pressure container.

30. The water supply system as claimed in claim 23, further comprising a sensor measuring the water pressure in the pipeline.

31. The water supply system as claimed in claim 23, wherein the pressure container has a volume of 10 to 20 m³.

32. The water supply system as claimed in claim 23, further comprising a pressure-equalized supply line supplying a metal processing line.

33. The water supply system as claimed in claim 32, wherein the metal processing line is a hot strip line in a mill rolling metal strip.
